(19) United States
(12) Patent Application Publication
(10) Pub. No.: US 2010/0221938 A1
(43) Pub. Date: Sep. 2, 2010

(54) Connector assembly for electronic cards and the preparation method thereof

(75) Inventor: Hsien-Chun Liu, Taipei (TW)

Correspondence Address: BACON & THOMAS, PLLC, 625 SLATERS LANE, FOURTH FLOOR, ALEXANDRIA, VA, 22314-1176, US

(73) Assignee: Santa Electronics Inc., Taipei (TW)

(21) Appl. No.: 12/379,712

(22) Filed: Feb. 27, 2009

(51) Int. Cl. H01R 13/62; H01R 24/00; B23K 20/10

(52) U.S. Cl. 439/152; 439/629; 228/110.1

(57) ABSTRACT

The present invention discloses a novel structure for the connector of electronic cards. The invented connector comprises a mode defining the outer shape of an electronic card, a first guide arm slidably provided at one side of said mode and a second guide arm slidably provided at the other side of said mode. The connector may further comprise a triangular guide rail and/or a card ejector. The connector may be affixed to a connector main body to form a connector assembly. The method for preparing the invented connector comprises the steps of: Preparing a mode defining an electronic card; slidably affixing a first guide arm at one side of the mode; and slidably affixing a second guide arm at one side of the mode. The invented method may further comprise the step of providing an ejector and/or a triangular guide rail at one guide arm. The invented method may further comprising the step of installing the first and second guide arms in a connector main body.

### FIELD OF THE INVENTION

The present invention relates to a novel connector assembly for the electronic cards and its preparation method, especially to a method for the preparation of the connector assembly using a mold and the connector assembly so prepared.

### BACKGROUND OF THE INVENTION

In the computer products the connector is an important component. The connector connects two or more electronic components, so that electric connections are established between or among them and that the electronic signals or other types of signal may be exchanged by them. The connector is thus widely used in all kinds of the computer, electronic or communication products.

In the IT industry there are a variety of standards for all kinds of products published by the private companies or by the industrial associations. The standards define the features of the related products in their shape, structure, size, electric characters and signal characters, so that the products that follow the standards may be shared by the same or different kinds of the computer, electronic and communication product. The design and the production of the computer, electronic and communication products are made easier, because the connections and the signal exchange between one product and another are standardized.

Take the electronic card as an example. The well-accepted industrial standards for the electronic card include the CardBus standard and the Express Card standard announced by the PCMCIA (the Personal Computer Memory Card International Association) and small-size electronic card standards announced by other associations such as the SD card standard. In addition, other standards such as the USB standard and the SATA standard are applicable in the electronic card as well. In the above examples, the CardBus standard and the ExpressCard standard define the electronic cards with relatively large size. Accordingly, the connectors provided for the electronic cards under these standards are large in size. As a result, a connector assembly for the larger size electronic cards is generally prepared in the computer, electronic and communication product to receive the electronic cards. On the other hand, the connectors in compliance with the electronic cards that follow other standards would be smaller in size, since the size of the electronic cards is smaller. For example, according to the CardBus standard announced by the PCMCIA, the electronic card is 54.0×86.6×33 mm in size. The connector part provided in the electronic card is 54.0 wide. The ExpressCard standard, on the other hand, provides two types of the electronic card. The rectangular card is 31.1×75.0×3.1 mm in size, while the L-shape card is 54.0×75.0×3.1 mm in size. The connector part for both types is 3.1 mm wide.

Due to the relatively large size of the CardBus and the ExpressCard electronic cards, the connector prepared in the computer, electronic and communication products in correspondence to these electronic cards shall include a space to receive the electronic cards. The space reserved for these electronic cards shall have a length that is the same or at least over a half of the length of the electronic cards. Rarely will the producer of the computer, electronic and communication products prepare a bare connector for these electronic cards. Accordingly, the connector is provided inside the computer, electronic and communication products at a length from the opening of the space. In order to support the electronic cards that reach deep into the computer, electronic and communication product, a support mechanism shall be provided in addition to the connector pins of the connector that provide the electric and signal connections. The support mechanism helps to guide the electronic card smoothly when it enters and exits the receiving space and to firmly and stably connect the electronic card to the connector. The support mechanism and the connector main body form a connector assembly for the large-size electronic cards.

However, also due to the large size of these electronic cards, the frame of the support mechanism at the connector side is also in a larger size. One result of this is that the structure of the connector assembly becomes unstable and tends to fold. This is particularly true in the case of the L-shape ExpressCard, wherein the connector assembly may form an L shape. Such nature brings difficulties in the production, assembly, storage, shipping and installation of the connector assembly. Several solutions have been proposed to solve this problem.

The first approach is to use a large size rectangular or L-shape metal shield to include the support mechanism and the connector main body. The connector main body is assembled to one end of the metal shield, while the opposite end functions as the inlet of the electronic card. At both sides of the shield, a guide rail is provided to support and to guide the electronic card when it approaches towards and away from the connector main body. Such a structure is rigid and provides a platform for the easy assembly of the other components of the connector assembly. Its disadvantages, however, are the waste of the shield material and the unnecessarily increased cost and weight of the connector assembly.

A second solution is to provide two guiding arms extending from the two sides of the connector main body to the inlet of the electronic card. Guide rails are provided in the guiding arms, which is made of plastic materials. Such guide arms are bulky, since they need to provide sufficient supports to the electronic card. The result is that the space occupied by the connector assembly is expanded accordingly. This is definitely not welcome in the industry. In addition, the longitudinal structure of the guiding arms tends to deform during the process and the assembly. Supplemental components are always necessary to strengthen the structure of the connector assembly, resulted at further waste of materials.

A modification of the second approach is to use metal guiding arms to replace the plastic guiding arms. The metal guiding arms help to shrink the size of the connector assembly. The use of the metal shield is thus avoided, whereby the cost and the weight of the whole assembly are reduced. Its disadvantages, however, are that the metal guiding arms are small in size and light in weight, therefore difficult to process and to assembly and that the assembly including the guiding arms would flex and bend during the process, assembly, shipping and installation. Unnecessarily intensive cares are needed in handling such a connector assembly.

It is thus necessary in the industry to provide a novel structure of the connector assembly what is stable, rigid and easy to handle during the process, assembly, shipping and installation. It is also necessary to provide a new preparation process for the connector assembly that is simple and low cost and is able to produce large-size connector assemblies in a stable and rigid manner.

### OBJECTIVES OF THE INVENTION

The objective of this invention is to provide a novel structure for the connector assembly for the electronic cards, especially the large size electronic cards.

Another objective of this invention is to provide a low cost, light weight and compact connector assembly for the electronic cards.

Another objective of this invention is to provide a simplified structure for the connector assembly for electronic cards.

Another objective of this invention is to provide a new preparation method for the connector assembly for electronic cards.

Another objective of this invention is to provide a preparation method for the connector assembly for electronic cards wherein no metal shield is necessary.

Another objective of this invention is to provide a simplified preparation method for the connector assembly for electronic cards.

Another objective of this invention is to provide a preparation method for the connector assembly for electronic cards, wherein the components of the connector assembly are stably supported during the process.

### SUMMARY OF THE INVENTION

According to the present invention, the preparation method of the connector assembly for electronic cards comprises the following steps:

prepare a mold of an electronic card;

slidably fix a first guiding arm in one side of said mold; and

slidably fix a second guiding arm in the other side of said mold.

In one preferred embodiment of the invented method, a step of fixing a card ejection mechanism to at least one of said guiding arms is further included. In another embodiment of the invention, the method may further comprise a step of fixing a guide rail board, which is preferably in a triangular shape, at one of the guiding arms. In addition, the invented method may further comprise a step of slidably fixing a connector main body to the mold. The connector main body may further be fixed to at least one of the guiding arms.

In addition, the invented method may also further comprise a step of removing said mold.

The connector assembly for electronic cards prepared in accordance with the above methods may comprise:

a mold to define the contour of an electronic card;

a first guiding arm slidably fixed to one side of said mold; and

a second guiding arm slidably fixed to the other side of said mold.

The invented connector assembly may further comprise a card ejection mechanism fixed to at least one of said guiding arms. The connector assembly may further comprise a guide rail board, which is preferably in a triangular shape, at one of the guiding arms. The connector assembly may further comprise a third guiding arm slidably fixed to one side of said mold. In addition, the connector assembly may further comprise a connector main body slidably fixed to the mold. The connector main body may further fixed to the guiding arms.

A guide groove is formed in said guiding arms, to support and to guide the electronic card. The guide arm may form electrical connections with said electronic card by, for example, enclosing the sides of said electronic card. Therefore, when assembly the guiding arms are affixed to the mold by inserting each side of the mold into the guide groove of the respective guiding arms, whereby each side of the mold is enclosed in the corresponding guiding arm and the mold is slidable in the guide grooves. Convex portions may be formed in the side walls of the guide groove to provide further supports to the electronic card. Extruders may be formed in the side walls of the guide groove to form electrical connections between the electronic card and the guiding arm. A fixing means may be provided in the guiding arms to fix the connector assembly to a substrate, such as the main circuit board. The fixing means may provide a bolt hole or form an L shape bracket, so to screw fasten, rivet, weld, solder, plug or fasten the guiding arms to the substrate, or PCB, of a computer, electronic or communications equipment. The shape of the two guiding arms may be the same or different. The materials of the two guiding arms may be the same or different.

In the present invention, it is preferable to use two guiding arms at the both sides of the mold. However, in some particular embodiments, one guiding arm is provided at one side of the mold, while two guiding arms are provided at the other side. In such a design, the mold defines an L-shape electronic card. The guide groove of the guiding arms may be in the Π shape or in the L shape. It may also be the C shape or the arc shape. The guiding arms may be longitudinal, L-shaped or Z-shaped.

If the assembly includes the connector main body, the connector main body may be fixed to a main circuit board before it is assembled with the mold. In addition, the card ejection mechanism and the guide rail board may be fixed to the guiding arm before the guiding arm is fixed to the mold. It is also possible to assemble the guiding arm to the mold before the card ejection mechanism or the guide rail board is fixed to the guiding arm.

These and other objectives and advantages of the present invention may be clearly understood from the detailed description by refereeing to the following drawings.

### BRIEF DESCRIPTION OF THE DRAWINGS

FIG. 1 shows the structure of the first embodiment of the connector assembly for electronic cards of this invention.

FIG. 2 shows the steps in the preparation of the first embodiment of the connector assembly for electronic cards of this embodiment.

FIG. 3 shows the structure of the second embodiment of the connector assembly for electronic cards of this invention.

FIG. 4 shows the structure of the third embodiment of the connector assembly for electronic cards of this invention.

FIG. 5 shows the steps in the preparation of the third embodiment of the connector assembly for electronic cards of this embodiment.

FIG. 6 shows the top view of the fourth embodiment of the connector assembly for electronic cards of this invention.

### DETAILED DESCRIPTION OF THE INVENTION

The present invention discloses a novel structure of the connector assembly for electronic cards and a totally new process in the preparation of the connector assembly for the electronic card. In the invented method, no metal shield or bulky guiding arms are needed. The connector assembly for electronic cards of the invention is rigid and stable during the assembly, shipping and installation. No special care is required in preventing the bending, deformation or damage of the connector assembly during the process of the assembly, shipping and installation.

The invented method comprises using a mold to define the outer shape of the electronic card and to function as the platform in the assembly, the shipping and the installation of the connector assembly. The assembly of the connector assembly is thus made easier and the connector assembly is made rigid and stable during all the processes.

The preparation method of the connector assembly for electronic cards according to this invention comprises the steps of:

prepare a mold of an electronic card;

slidably fix a first guiding arm in one side of said mold; and

slidably fix a second guiding arm in the other side of said mold.

The invented method may further comprise a step of fixing a card ejection mechanism to one of said guiding arms. It may further comprise a step of fixing a guide rail board, which is preferably in a triangular shape, at one of the guiding arms. In addition, the invented method may further comprise a step of slidably fixing a connector main body to the mold. Since in the completed assembly, the main components are slidably fixed to the mold, a further step of removing the mold may be used after the preparation or the installation of the connector assembly. The connector main body may be fixed to the main circuit board before it is fixed to the mold. The invented method may further comprise a step of fixing the connector main body to at least one of the guiding arms.

The connector assembly for electronic cards prepared in accordance with the present invention comprises:

a mold to define the contour of an electronic card;

a first guiding arm slidably fixed to one side of said mold; and

a second guiding arm slidably fixed to the other side of said mold.

The invented connector assembly may further comprise a card ejection mechanism fixed to at least one of said guiding arms. The connector assembly may further comprise a guide rail board, which is preferably in a triangular shape, at one of the guiding arms. The connector assembly may further comprise a third guiding arm slidably fixed to one side of said mold. In addition, the connector assembly may further comprise a connector main body slidably fixed to the mold. The connector main body may further be fixed to at least one of the guiding arms.

In the above-described connector assembly for electronic cards, the mold may be made of any rigid material. Useful materials include: Metal, alloy, plastics, rubber, resin, wood, paper, glass, ceramics or their combinations. The shape of the mold is not limited to any particular shape, as long as it can maintain the relative position of the guiding arms at the both sides of the mold and the mold, whereby processing and handling of the assembly are made smooth. In some embodiments of the present invention, the shape of the mold is substantially equivalent to the shape of the electronic card to be in connection with the connector main body. In some other embodiment, the shape of the mold defines the contour or a part thereof, of the electronic card.

The electronic card which outer shape is defined by the mold is not limited to one defined by the industrial standards. Any commercially available electronic card that is in the market nowadays or will be available in the future may be used as the template in the design of the mold. In addition, any electronic device that is connectable to a connector may be used as the “electronic card” of this invention. The material of the guiding arms is preferably metal, especially metal materials with relatively high conductivities. Applicable materials include iron, steel, aluminum, tin, copper, silver etc. This, however, is not any technical limitation of this invention. For example, the materials used in the commercially available shield of the connector assembly are useful. Non-metal materials useful in the preparation of the guiding arms include any rigid and light-weighted material, such as reinforced plastics, resin, paper or porous ceramics. However, due to the international EMR regulations, conductive extruders and wires shall be provided in the guiding arms to guide the electromagnetic emersions generated by the electronic card, if the guiding arms are not made in the metal materials. These arrangements are known to those skilled in the art. In application, the first and second guiding arms may be metal, while the third guiding arm may be plastic or metal. Again, this is not any technical limitation of the present invention.

The shape of the guiding arms is generally longitudinal, with the length thereof not limited to any particular figure. Generally speaking, the length of one of the guiding arms is preferably longer than half of the length of the electronic card, so to stably support the electronic card. Some manufacturers of the computer, electronic and communications equipments would request that the length of the guiding arms shall be at least equal to that of the electronic card. This, however, is not any technical limitation. Preferably, a longitudinal guide groove is provided in the guiding arms, to support and to guide the movement of the electronic card. If necessary, electrical contacts between the guiding arms and the electronic card are provided. The guide groove may be in the Π shape or in the L shape. It may also be the C shape or the arc shape. The guiding arms may be longitudinal, L-shaped or Z-shaped. At the upper and lower walls of the guide groove, or only in the lower wall in the case of the L-shaped guide groove, the well-known extruder, convex portion or other supplemental arrangements may be provided, to elastically support the electronic card, to electrically connect the electronic card to the guiding arm or to provide other supplemental functions. A fixing means may be provided in the guiding arms to fix the connector assembly to a substrate, such as the main circuit board. The fixing means may provide a bolt hole or form an L shape with a stand, so to screw fasten, rivet, weld, solder, plug or fasten the guiding arms to the substrate, or PCB, of a computer, electronic or communications equipment.

In the present invention, it is preferable to use two guiding arms at the respective sides of the mold. However, the number of the guiding arms at one side of the mold is not limited to one, as long as the guiding arms may stably support the electronic card. In some particular embodiments three guiding arms are used, with one guiding arm provided at one side of the mold and two guiding arms provided at the other side. In such a design, the mold defines an L-shape electronic card. The guide groove of the guiding arms may be the same of different.

The guiding arms as described above may be prepared with any known art. For example, if the material of the guiding arms is metal, the guiding arms, as well as the extruders, the convex portions and the fixing means, may be formed by a stamping machine. The fixing means may be separately prepared and screw fastened, riveted, soldered, welded, plugged or fastened to the guiding arms. If the welding process is adopted, applicable approaches include the spot welding, the ultrasonic welding, the surface mounting and other technologies. On the other hand, if the guiding arms are made of plastics, they may be formed by the injection molding process. In addition, it is possible to assemble a plurality of components, by e.g. sleeve jointing, welding, soldering, screw fastening etc., to form one single guiding arm. These are all known to those skilled in the art. In addition, if two or more guiding arms are used in one side of the mold, they may be connected or separated. In one preferred embodiment of the present invention, two or more guiding arms are used in one side of the mold without connecting them together.

If the connector assemble is to support an L-shaped electronic card, a stopper may be formed at the second guiding arm. The stopper and the main portion of the second guiding arm (called the “first guiding portion” hereinafter) form an L shape. If necessary, a second guiding portion may be further formed in the second guiding arm, whereby the second guiding arm would include the first guiding arm, the stopper and the second guiding arm; the shape of the second guiding arm forms a Z shape. Another arrangement is to slidably fix a second guiding arm and a third guiding arm in one side of the mold, whereby no stopper is provided in that side. No matter the guiding arm is in the longitudinal shape, the L shape or the Z shape, it may be prepared in one piece or by joining two or more components.

In a connector assembly that supports the L shape electronic card, preferably a guide rail board in the triangular shape is prepared at the position corresponding to the front of the notched portion of the L-shaped card. The position of the guiding rail board may be referred to the ExpressCard Standard published by the PCMCIA (the Personal Computer Memory Card International Association), in the portion relating to the size and shape of the L-shaped electronic card. The triangular guide rail board generally comprises a right triangular plate at the thickness of about 1 mm, in pursuant to the ExpressCard Standard, with two side walls at the base and the side. The function of the side walls is to fix the guide rail board to the guiding arm. Therefore, whether the side walls are prepared and what the shape of the side walls are, shall be determined according to design of the guiding arm. In general it is preferable to prepare two side walls in the guide rail board and to fix the guide rail board to the L-shaped or Z-shaped second guiding arm. However, it is possible to prepare only one side wall and fix the guide rail board to the longitudinal or L-shaped second guiding arm.

In the present invention a mold is used in the handling of the connector assembly. Therefore, it is not necessary to connect the guiding arms and the connector main body, to form a piece, after the assembly is completed.

The connector main body of the present invention is basically the same as those commercially available in the market. The connector main body includes a plurality of connector pins and the insulation main body that surrounds the plurality of connector pins. The specification, shape and arrangement of the connector pins and the shape, structure and size of the insulation main body are preferably complying with the industrial standards. There is not particular technical limitation in the material, process or other features of the connector main body. Fixing means may be prepared in the connector main body, so to fix the connector assembly to the main circuit board after it is installed in the main circuit board. The fixing means may be any applicable means, such as a detent pin, a fastener or a bolt hole. In most applications, the connector main body is fixed to the main circuit board by soldering the connector pins of the connector main body to the main circuit board.

The card ejection mechanism may be any known card ejector, in particular the push-push ejector. In general the card ejection mechanism includes a push rod, a coil spring and a heart-shaped cam slot. The push rod generally has a topper positioned in the traveling space of the electronic card defined by the two guiding arms and the connector main body, at adjacent to the connector main body. The stopper is used to push the electronic card, to move it from the connected position, and to be pushed by the electronic card, when the electronic card approaches to the connected position. The push rod further has a pin positioned inside the heart-shaped cam slot. When the stopper of the push rod is pushed by an electronic card, the push rod moves towards the connector main body, whereby the coil spring is depressed (or elongated), until the electronic card is positioned at the connected position. When the stopper is pushed by the electronic card again, it moves further forward to the connector main body, whereby the locking situation of the push rod is released due to the function of the pin and the heart-shaped cam slot. The force of the coil spring pulls the push rod, so that it moves towards the inlet of the electronic card, whereby the electronic card is pushed by the stopper and moves from its connected position towards the inlet. Such card ejection mechanism is well known to those skilled in the art. Detailed descriptions thereof are thus omitted.

What is critical is that the card ejection mechanism is preferably fixed to one of the guiding arms, instead of slidably fixed thereto. Under such an arrangement it is not necessary to additionally fix the card ejection mechanism to the main circuit board during the installation of the connector assembly. The card ejection mechanism may be fixed to the guiding arm by plugging, fastening, riveting, welding or soldering, as long as it is firmly fastened to the guiding arm. Such technology is also well known in the industry. Detailed descriptions thereof are thus omitted.

The connector assembly for electronic cards so prepared comprises a mold and a first and a second guiding arms slidably fixed to the mold. It may further comprise a card ejection mechanism, fixed to at least one of the guiding arms. It may further comprise a guide rail board, preferably in the triangular shape, fixed to at least one of the guiding arms. It may further comprise a third guiding arm slidably fixed to one side of the mold. It may further comprise a connector main body slidably fixed to the mold. The connector main body may further fixed to at least one of the first and second guiding arms. The guiding arms may be longitudinal, L-shaped or Z-shaped. It may be the combination of two separated guiding arms. The shape of the guiding arms may be the same or different.

Preferably a guide groove is formed in the guiding arms. Convex portions and/or extruders may be formed at the wall(s) of the guide groove. The convex portions serve to elastically support the electronic card and the extruder serve to produce electrical connections between the electronic card and the guiding arm. Fixing means may be provided in each of the guiding arms, whereby the guiding arms may be fixed to the substrate, or PCB, of a computer, electronic or communications equipment. The fixing means may provide a bolt hole or form an L shape bracket, so to screw fasten, rivet, weld, solder, plug or fasten the guiding arms to the main circuit board. The spot welding and the ultrasonic welding are two preferable ways to fix the guiding arms. Fixing means may also be prepared in the connector main body to provide similar functions.

The connector assembly for electronic card so accomplished is positioned relatively to a connector main body, which is fixed to the main circuit board. After fixing the guiding arms, the mold is removed, whereby a complete connector assembly is prepared and installed.

The followings are the detailed descriptions of the embodiments of the connector assembly and its preparation method according to the present invention.

### Embodiment I

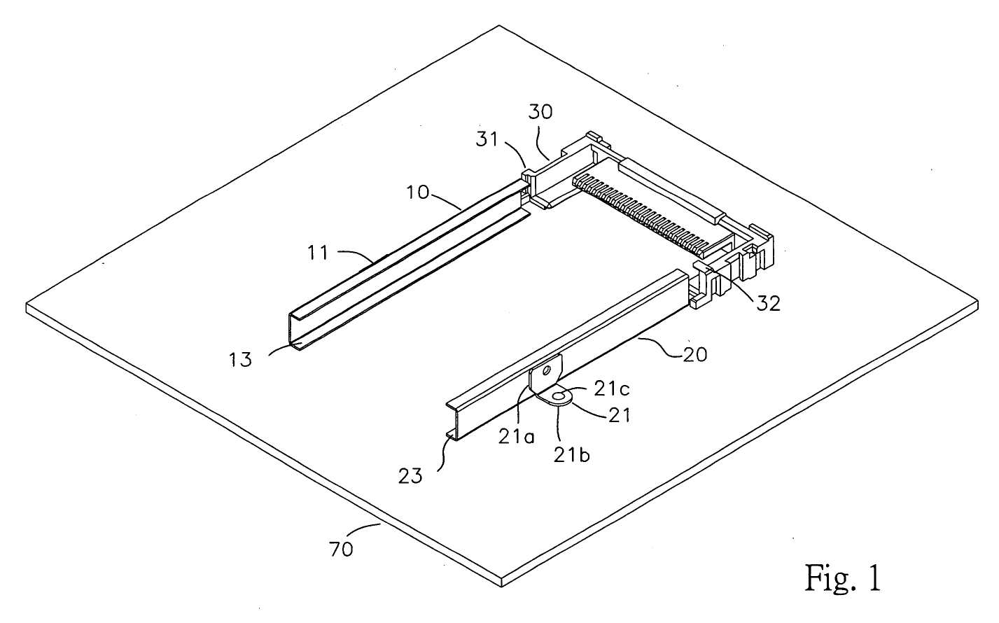

FIG. 1 shows the structure of the first embodiment of the connector assembly for electronic cards of this invention. As shown in FIG. 1, the connector assembly for electronic card comprises: a mold 10, a first guiding arm 31 and a second guiding arm 32. The mold 10 is rectangular, defining a rectangular electronic card. The guiding arms 31, 32 are slidably fixed to the mold 10. In this figure a connector main body 20 is shown. The connector main body 20 is fixed to the main circuit board, with its connector pins being in electrical connections with the circuits (not shown) in the main circuit board 20. Fasteners 21, 22 are provided in the connector main body 20. The fasteners 21, 22 may extend into the interior of the guiding arms 31, 32, respectively, until they are locked by the notches (not shown) inside the guiding arms 31, 32, whereby the first guiding arm 31 and the second guiding arm 32 are fixed firmly to the connector main body 20.

The guiding arms 31 and 32 are made of steel, with a “Π” shape cross-sectional view. Thereby the longitudinal of the guiding arms forms a guide groove 311, 321, to support and to guide the electronic card in its movement to and from the connector main body. The guide grooves 311, 321 produce electrical connections between the guiding arms 31, 32 and the electronic card, whereby the electromagnetic emersions generated by the electronic card may be lead to the main circuit board 60 through the guiding arms 31, 32.

The connector main body 20 is substantially the same in structure as those commercially available in the market. In the present invention, the connector main body 20 is connected to the guiding arms 31, 32 using the fasteners 21, 22 and the notches in the guiding arms 31, 32. Two stoppers (not shown) may be formed at the terminals of the respective guiding arms 31, 32 to clamp the connector main body 20, so to firmly fix the guiding arms 31, 32 to the connector main body 20.

When assembling the connector main body 20 is generally fixed to the main circuit board by welding the connector pins of the connector main body 20 to the wires (not shown) in the main circuit board 60, to form electrical connections between the connector main body 20 and the main circuit board 60, before the connector main body 20 is fixed to the guiding arms 31, 32.

A fixing means 33, 34 is provided at the outer side of the guiding arms 31, 32, to allow the screw fastening of the connector assembly to the main circuit board 60. If necessary, similar fixing means may be provided in the connector main body 20, to provide similar functions. The fixing means 33, 34 further provide the function of electronically connecting the guiding arms to the main circuit board 60. After the assembly of the mold and the guiding arms as shown in FIG. 1 is assembled with the connector main body 20, the full connector assembly is fixed to the main circuit board 60. After the mold 10 is removed, the components of the connector assembly form a complete connector assembly for electronic cards.

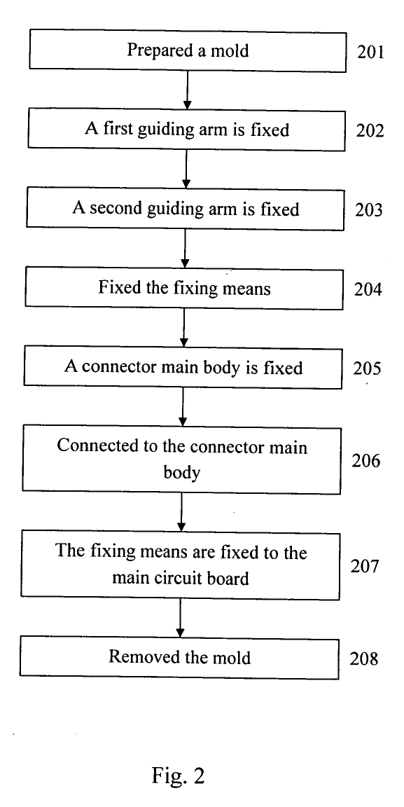

FIG. 2 shows the steps in the preparation of the connector assembly for electronic cards of this embodiment. As shown in the figure, at 201 a mold 20 is prepared. The mold 10 defines the shape of a rectangular electronic card. At 202 at one side of the mold 10 a first guiding arm 31 is fixed. At 203 a second guiding arm 32 is fixed to the other side of the mold 10. The first guiding arm 31 and the second guiding arm 32 are slidably fixed to the mold 10 by inserting a side of the mold 10 to the guide groove of the respective guiding arms 31, 32. Thereafter, at 204 the fixing means 33, 34 are fixed to the respective guiding arms 31, 32 by spot welding or ultrasonic welding. At 205 a connector main body 20 is fixed to the main circuit board 60. At 206 the assembly of the mold 10, the first guiding arm 31 and the second guiding arm 32 is connected to the connector main body 20 by inserting the fasteners 21, 22 of the connector main body 20 into the interior of the guiding arms 31, 32, whereby the extruders of the fasteners 21, 22 are locked by the notches of the guiding arms 31, 32 and the stoppers of the guiding arms 31, 32 contact the front end of the respective guiding arms 31, 32. Since the connector main body 20 is fixed to the main circuit board 60, at 207 the fixing means 33, 34 are fixed to the main circuit board 60. The assembly of the connector assembly is thus completed. After the mold 10 is removed at 208, the connector assembly is ready for use.

### Embodiment II

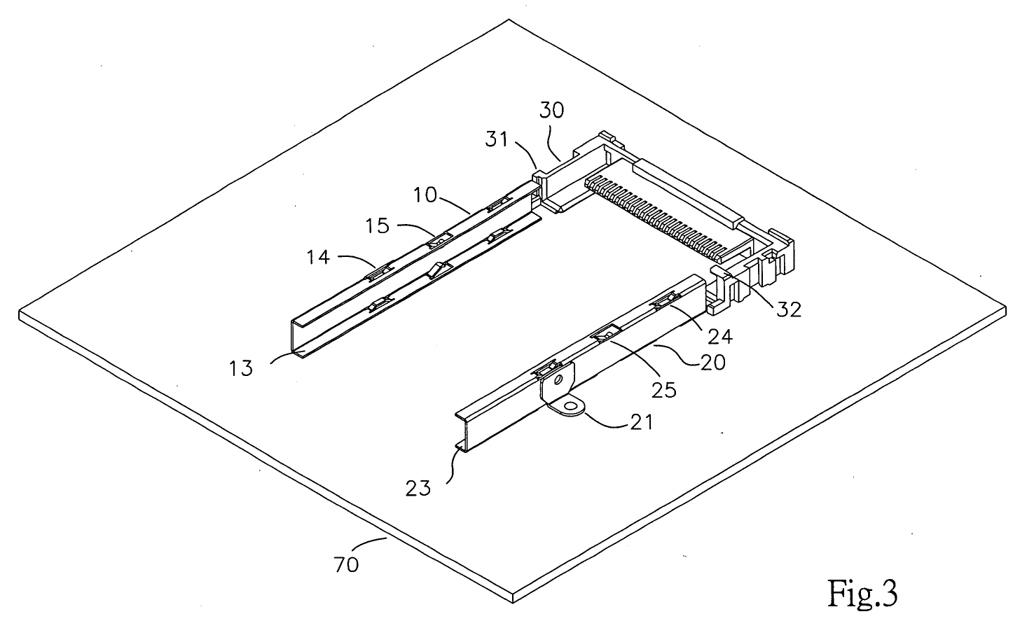

FIG. 3 shows the structure of the second embodiment of the connector assembly for electronic cards of this invention. The components that are the same as those in FIG. 1 are labeled with the same numbers. The structure of the second embodiment is substantially the same as that of the first embodiment, except that a plurality of convex portions 35, 36 is formed in the guide grooves 311, 321 of the guiding arms 31, 32. The convex portions 35, 36 extend into the interior of the guide grooves 311, 321, to provide further supports to the electronic card. In addition, a plurality of extruders 37, 38 are provided in the guide grooves 311, 321 of the guiding arms 31, 32. The extruders 37, 38 also extend into the interior of the guide grooves 311, 321, to provide more stable electrical contacts between the guiding arms 31, 32 and the electronic card.

The connector assembly for electronic cards so prepared may be used to accept the rectangular electronic card. The preparation of the connector assembly of FIG. 3 is the same as that of FIG. 2, except that the convex portions 35, 36 and the extruder 37, 38 shall be prepared when preparing the guiding arms 31, 32.

### Embodiment III

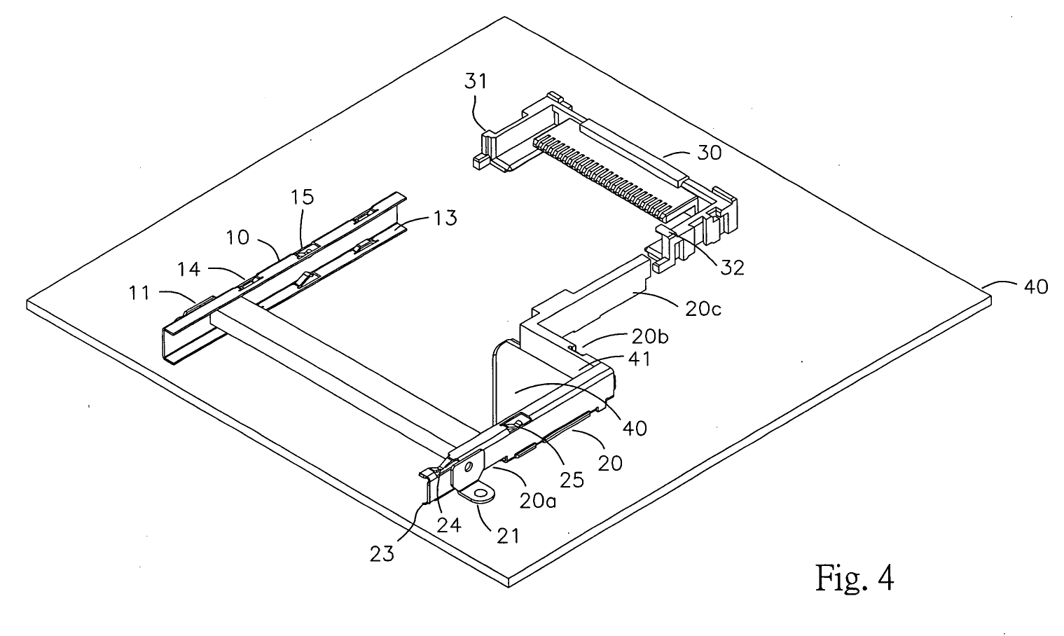

FIG. 4 shows the structure of the third embodiment of the connector assembly for electronic cards of this invention. The components that are the same as those in FIGS. 1 and 3 are labeled with the same numbers. The connector assembly shown in FIG. 4 has substantially the same structure as that of the preceding embodiments, except that the shape of the connector assembly in this example is L-shaped.

As shown in the figure, the connector assembly for electronic card comprises: a mold 10, a first guiding arm 31, a second guiding arm 32 and a guide rail board 40. The mold 10 is in the L shape, defining an L-shaped electronic card. The guiding arms 31, 32 are slidably fixed to the mold 10. The first guiding arm 31 is longitudinal and the second guiding arm 32 is in the Z shape, i.e. a three-folded shape. The second guiding arm 32 has a first guiding portion 324, a stopper 325 and a second guiding portion 326. The guide rail board 40 has a right triangular plate and has side walls 41 at its base and side. The guide rail board 40 is fixed to the first guiding portion 324 of the second guiding arm 32 by inserting an extruder (not shown) of its side wall 41 into the notch (not shown) at the first guiding portion 324. In compliance with the right triangular shape of the guide rail board 40, a recession (not shown) is provided at the mold 10, at the position corresponding to the guide rail board 40. The shape of the recession may be triangular, as the shape of the electronic card described in the ExpressCard Standard.

The guiding arms 31, 32 may be further provided with a plurality of convex portions 35, 36, extending into the respective guide grooves 311, 321 to support the electronic card. Extruders 37, 38 may also be provided in the guide grooves 311, 321 of the guiding arms 31, 32 to produce stable electrical contacts between the guiding arms 31, 32 and the electronic card. Details of the convex portions 35, 36 and the extruders 37, 38 are described in the description of the second embodiment. In this figure a connector main body 20 is shown. The connector main body 20 is fixed to the main circuit board, with its connector pins being in electrical connections with the circuits (not shown) in the main circuit board 20. Fasteners 21, 22 are provided in the connector main body 20. The fasteners 21, 22 may extend into the interior of the guiding arms 31, 32, respectively, until they are locked by the notches (not shown) inside the guiding arms 31, 32, whereby the first guiding arm 31 and the second guiding arm 32 are fixed firmly to the connector main body 20.

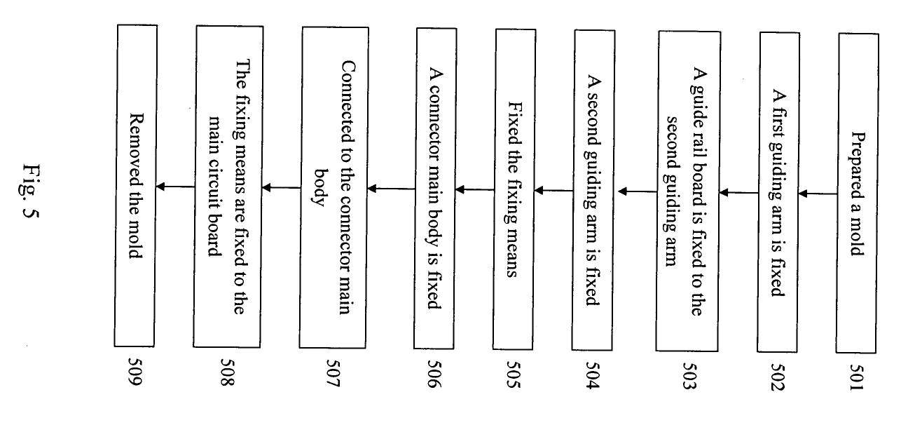

FIG. 5 shows the steps in the preparation of the connector assembly for electronic cards of this embodiment. As shown in the figure, at 501 a mold 20 is prepared. The mold 10 defines the shape of an L-shaped electronic card. At 502 at one side of the mold 10 a first guiding arm 31 is fixed. The first guiding arm 31 is slidably fixed to the mold 10 by inserting the one side of the mold 10 to the guide groove of the guiding arm 31. At 503 a guide rail board 40 is fixed to the second guiding arm 32 by sliding the guide rail board 40 into the guide groove 321, until it reaches the front end of the first guiding portion 324. At 504 the second guiding arm 32 is fixed to the other side of the mold 10 by inserting the other side of the mold 10 into the guiding groove 321 of the second guiding arm 32. Thereafter, at 505 the fixing means 33, 34 are fixed to the respective guiding arms 31, 32 by spot welding or ultrasonic welding. At 506 a connector main body 20 is fixed to the main circuit board 60. At 507 the assembly of the mold 10, the first guiding arm 31 and the second guiding arm 32 is connected to the connector main body 20 by inserting the fasteners 21, 22 of the connector main body 20 into the interior of the guiding arms 31, 32, whereby the extruders of the fasteners 21, 22 are locked by the notches of the guiding arms 31, 32 and the stoppers of the guiding arms 31, 32 contact the front end of the respective guiding arms 31, 32. At 508 the fixing means 33, 34 are fixed to the main circuit board 60. The assembly of the connector assembly is thus completed. Before using the connector assembly, the mold 10 is removed at 509.

In this embodiment the second guiding arm 32 is in the three-folded shape. In other embodiments, however, the second guiding arm 32 is rectangular or L-shaped. In the latter examples, the preparation of the connector assembly is basically the same as in this embodiment. In yet another embodiment, a second guiding arm and a third guiding arm (not shown) are provided at the same side of the mold, forming a guiding arm with two separate parts. In such a case, in the assembly the outer edge at the side of the mold with the notch is first inserted into the second guiding arm 32, followed by inserting the inner side into the third guiding arm, to complete the slidable fixing of the second and third guiding arms.

The connector assembly so prepared may receive both the rectangular and the L-shaped electronic cards, after it is installed in the main circuit board and the electrical contacts between the connector assembly and the wires in the main circuit board is established.

### Embodiment IV

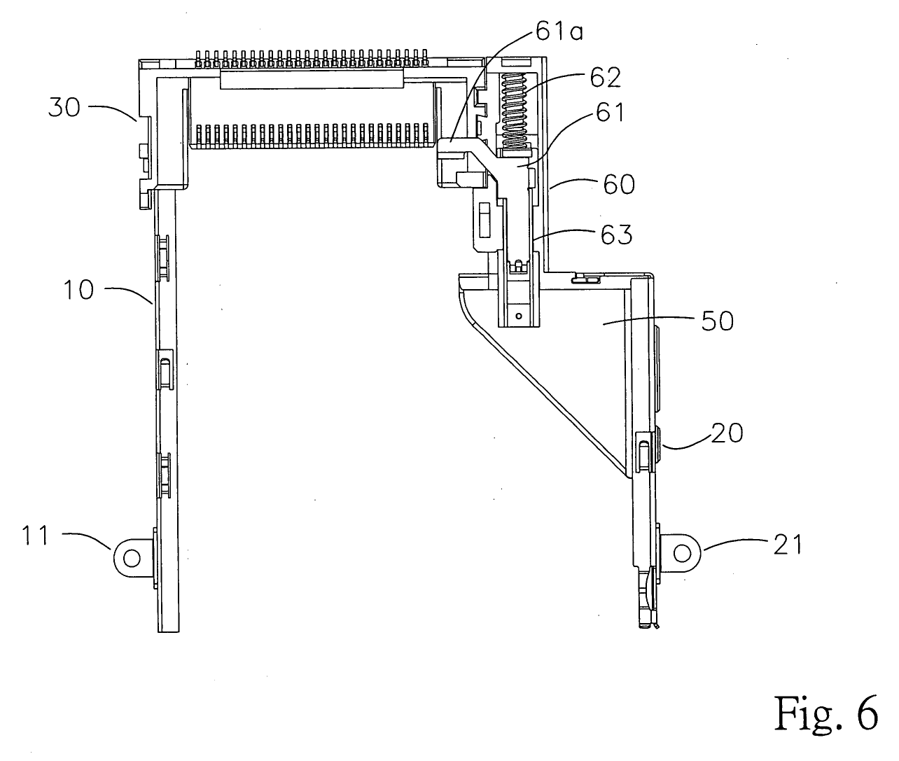

FIG. 6 shows the top view of the fourth embodiment of the connector assembly for electronic cards of this invention. The components that are the same as those in the preceding figures are labeled with the same numbers. The connector assembly shown in FIG. 6 has substantially the same structure as that of the third embodiments, except that a card ejection mechanism is provided in this embodiment.

As shown in the figure, the connector assembly for electronic card of this embodiment comprises: a mold 10, a first guiding arm 31, a second guiding arm 32, a guide rail board 40 and a card ejection mechanism 50. A connector main body 20 is fixed to the main circuit board (not shown) and the electrical contacts are established. In addition, an electronic card 70 is shown in this figure.

The card ejection mechanism 50 has the same structure as that of the conventional push-push type card ejector and comprises: a push rod 51, a compression spring 52 and a heart-shaped cam slot 53. The push rod 51 has a stopper 51a, positioned in the traveling space of the electronic card, as defined by the two guiding arms and the connector main body, at adjacent to the connector main body. The stopper 51a is used to push the electronic card 70, to move it from the connected position, and to be pushed by the electronic card 70, when the electronic card 70 approaches to the connector main body 20. The push rod 51 further has a pin (not shown) positioned inside the heart-shaped cam slot 53. The heart-shaped cam slot 53 is so designed that, when the stopper 51a of the push rod 51 is pushed by the electronic card 70, the push rod 51 moves towards the connector main body 20, whereby the compression spring 52 is depressed, until the electronic card 70 is positioned at the connected position. Thereby the push rod 51 is locked in the connected position. When the stopper 51a is pushed by the electronic card 70 again, it moves further forward to the connector main body 20, whereby the locking status of the push rod 51 is released. The force of the compression spring 52 pulls the push rod 51, so that it moves towards the inlet, whereby the electronic card 70 is pushed by the stopper 51a and moves from its connected position towards the inlet. Such card ejection mechanism is well known to those skilled in the art.

The card ejection mechanism 50 is fixed to the second guiding arm 32 at the outer side of the second guiding portion 323, by e.g. a fastener (not shown). The connector assembly for electronic cards so prepared is fixed to the main circuit board to receive both the rectangular and the L-shaped electronic cards. The preparation of the connector assembly of this embodiment is basically the same as that of the third embodiment, except that in assembling the second guiding arm 32, step 504 shall be changed to:

At first the other side of the mold 10 is inserted to the guiding groove 321 of the second guiding arm 32. Then the card ejection mechanism 50 is fixed to the second guiding portion 323 of the second guiding arm 32. The assembly of the second guiding arm 32 is thus completed.

This invention presents a totally new method in the preparation of the connector assembly for electronic cards. The connector assembly so prepared has a structure that is totally different from that of the conventional art. In the invented connector assembly no metal shield or other supplemental components are required. The connector assembly is rigid and maintains a stable structure during the preparation, assembly, shipping and installation of the connector assembly. The mold has a simple shape and structure and may be easily prepared under very low costs. The mold functions as the platform in the assembly and the installation of the connector assembly. The preparation process of the connector assembly is thus made easily.

As the present invention has been shown and described with reference to preferred embodiments thereof, those skilled in the art will recognize that the above and other changes may be made therein without departing form the spirit and scope of the invention.

What is claimed is:

1. Method for preparation of connector assembly for electronic cards, comprising the steps of:
prepare a mold having a shape representing a part of the contour of an electronic card;
slidably fix a first guiding arm in one side of said mold; and
slidably fix a second guiding arm in the other side of said mold.

2. The method according to claim 1, further comprising the step of fixing a connector main body to said connector assembly.

3. The method according to claim 1, wherein said second guiding arm has a three-folded shape, whereby said first and second guiding arms define the shape of an L-shaped electronic card.

4. The method according to claim 1, wherein a guide groove is formed in each of said first and second guiding arms, to enclose a side of said mold.

5. The method according to claim 4, wherein the steps of slidably fixing said first guiding arm and said second guiding arms to said mold comprise inserting said mold into said guide grooves of said first guiding arm and said second guiding arms.

6. The method according to claim 5, wherein a plurality of convex portions is formed in said guide grooves.

7. The method according to claim 4, wherein the steps of slidably fixing said first guiding arm and said second guiding arms to said mold comprise the steps of: inserting said mold into said guide groove of said first guiding arm; fixing a guide rail board to said second guiding arm; and inserting said mold into said guide groove of said second guiding arm.

8. The method according to claim 1, further comprising the step of fixing a guide rail board to at least one of said guiding arms.

9. The method according to claim 1, further comprising the step of fixing a card ejection mechanism to at least one of said guiding arms.

10. The method according to claim 1, further comprising the step of fixing a fixing means to one said guiding arm, after said guiding arm is slidably fixed to said mold.

11. The method according to claim 10, wherein fixing said fixing means comprises spot welding said fixing means to said at least one guiding arm.

12. The method according to claim 10, wherein fixing said fixing means comprises ultrasonically welding said fixing means to said at least one guiding arm.

13. The method according to claim 2, wherein said connector main body is fixed to a substrate before it is fixed to said connector assembly.

14. The method according to claim 1, further comprising the step of removing said mold from said connector assembly.

15. The method according to claim 1, further comprising the step of slidably fixing a third guiding arm to a side of said mold.

16. Connector assembly for electronic cards, comprising:
a mold to define a part of the contour of an electronic card;
a first guiding arm slidably fixed to one side of said mold; and
a second guiding arm slidably fixed to the other side of said mold.

17. The connector assembly according to claim 16, further comprising a card ejection mechanism fixed to at least one of said guiding arms.

18. The connector assembly according to claim 16, further comprising a connector main body fixed to said guiding arms.

19. The connector assembly according to claim 16, wherein said second guiding arm has a three-folded shape, whereby said first and second guiding arms define the shape of an L-shaped electronic card.

20. The connector assembly according to claim 19, further comprising a guide rail board fixed to at least one of said guiding arms.

21. The connector assembly according to claim 16, wherein a guide groove is formed in each of said first and second guiding arms, to enclose a side of said mold.

22. The connector assembly according to claim 21, wherein a plurality of convex portions is formed in said guide grooves.

23. The connector assembly according to claim 17, wherein said card ejection mechanism is fixed to said second guiding arm.

24. The connector assembly according to claim 16, further comprising a fixing means provided at each of said guiding arms.

25. The connector assembly according to claim 24, wherein said fixing means is spot welded to one said guiding arm.

26. The connector assembly according to claim 24, wherein said fixing means is ultrasonically welded to one said guiding arm.

27. The connector assembly according to claim 16, further comprising a third guiding arm slidably fixed to a side of said mold.
